(19) United States
(12) Patent Application Publication
(10) Pub. No.: US 2018/0315142 A1
(43) Pub. Date: Nov. 1, 2018

(54) DETECTING VIOLATIONS IN ADVERTISEMENTS

(71) Applicant: GOOGLE INC., Mountain View, CA (US)

(72) Inventors: Matthew SHULMAN, Mountain View, CA (US); Prashant C. FULORIA, Los Altos, CA (US)

(21) Appl. No.: 14/335,041

(22) Filed: Jul. 18, 2014

Related U.S. Application Data
(63) Continuation of application No. 14/038,074, filed on Sep. 26, 2013, now abandoned.
Application No. 14/038,074 is a continuation of application No. 11/239,292, filed on Sep. 30, 2005, now abandoned.

(51) Int. Cl. G06Q 50/18; G06Q 30/02

(52) U.S. Cl. CPC G06Q 50/184; G06Q 30/0248

(57) ABSTRACT

A system identifies occurrences of potential violations in a set of advertisements and identifies ones of the advertisements that contains one or more occurrences of one of the potential violations or a spelling variation of the one of the potential violations. The system sequentially processes each of the identified advertisements in a number of stages to determine whether the one of the potential violations in the advertisement is an actual violation.

### BACKGROUND

### Field of the Invention

Implementations described herein relate generally to advertising and, more particularly, to the detection of violations in advertisements.

### Description of Related Art

An on-line advertising system may provide advertising links (also referred to as “impressions” hereinafter) to users when they perform web searches or visit certain web pages. When a particular advertising link is of interest to a user, a user may select (or click) the advertising link, which may cause the user's web browser to visit a web page belonging to the advertiser associated with the advertising link. This selection of an advertising link by a user is referred to hereinafter as a “click.”

It would be beneficial for an advertiser to have its advertisements presented when a user searches for a competitor's product or service. Sometimes, an advertiser will use a competitor's trademark either in the advertisement itself or as a keyword that triggers display of the advertisement.

In some countries, depending on local trademark laws, a trademark owner can request that competitor's advertisements not be shown when the trademark term is searched by a user. For example, the trademark “Sheraton” is owned by The Sheraton Corporation for use in the hotel industry. In some countries, Sheraton may request that no advertisements related to the hotel industry be shown when the user performs a search for “Sheraton.” The amount of trademark protection varies from country to country. To comply with the trademark laws, advertisements that contain unauthorized trademarks should be disabled.

Manual systems exist that require examination of each advertisement one at a time. In a typical system, a human operator reads each advertisement individually and makes a decision about whether the use of the trademark is authorized or unauthorized. This is very labor-intensive and, therefore, very expensive.

### SUMMARY

According to one aspect, a system may include a set of catch filters to determine whether an advertisement, which includes intellectual property in a content of the advertisement or a keyword associated with the advertisement, contains a potential intellectual property violation; and a set of release filters to determine whether the advertisement contains an actual intellectual property violation when the advertisement is determined to contain a potential intellectual property violation by the set of catch filters.

According to another aspect, a system may include means for identifying occurrences of potential violations in a set of advertisements, means for identifying ones of the advertisements that contain one or more occurrences of one of the potential violations or a spelling variation of the one of the potential violations, and means for sequentially processing each of the identified advertisements in a plurality of stages to determine whether the one of the potential violations in the advertisement is an actual violation.

According to yet another aspect, a method may include determining whether an advertisement does not infringe intellectual property based on whether there is an overlap between a first set of countries to which the advertisement is targeted and a second set of countries where the intellectual property is registered; determining whether the advertisement does not infringe the intellectual property based on whether a catch keyword in a set of catch keywords that relate to a topic associated with the intellectual property matches a content or a keyword associated with the advertisement; determining whether the advertisement does not infringe the intellectual property based on whether an account identifier corresponding to an advertiser associated with the advertisement matches an account identifier in a list of account identifiers; determining whether the advertisement does not infringe the intellectual property based on whether an address pointed to by the advertisement matches an address in a list of addresses; and determining whether the advertisement does not infringe the intellectual property based on whether a release keyword in a set of release keywords that are unrelated to a topic associated with the intellectual property matches a content or a keyword associated with the advertisement.

According to a further aspect, a system may include an ad system capable of reviewing millions of advertisements and hundreds of millions of keywords associated with the advertisements to detect ones of the advertisements that include violations.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIG. 1 is an exemplary diagram illustrating a concept consistent with the principles of the invention;

FIG. 2 is an exemplary diagram of a network in which systems and methods consistent with the principles of the invention may be implemented;

FIG. 3 is an exemplary diagram of an entity that may correspond to one or more of the clients, servers, or ad system of FIG. 2;

FIG. 4 is an exemplary functional block diagram of a portion of the ad system of FIG. 2;

FIG. 5 is an exemplary functional block diagram of the filter pipeline of FIG. 4;

FIG. 6 is an exemplary functional block diagram of the catch and release filters of FIG. 5;

FIGS. 7 and 8 are flowcharts illustrating an exemplary operation for processing advertisements according to an implementation consistent with the principles of the invention; and

FIGS. 9 and 10 are diagrams that facilitate description of the exemplary operation of FIGS. 7 and 8.

### DETAILED DESCRIPTION

The following detailed description of the invention refers to the accompanying drawings. The same reference numbers in different drawings may identify the same or similar elements. Also, the following detailed description does not limit the invention.

### Overview

Implementations consistent with the principles of the invention are directed to detecting violations in advertisements. A “violation” can relate to an unauthorized use of a trademark, copyright, service mark, trade name, or another form of intellectual property, or use of a restricted word (e.g., a word that violates a policy of an advertising system (e.g., profanity)). Implementations described herein can detect violations that appear in the advertisement text itself and in the keywords used to trigger the display of the advertisement text.

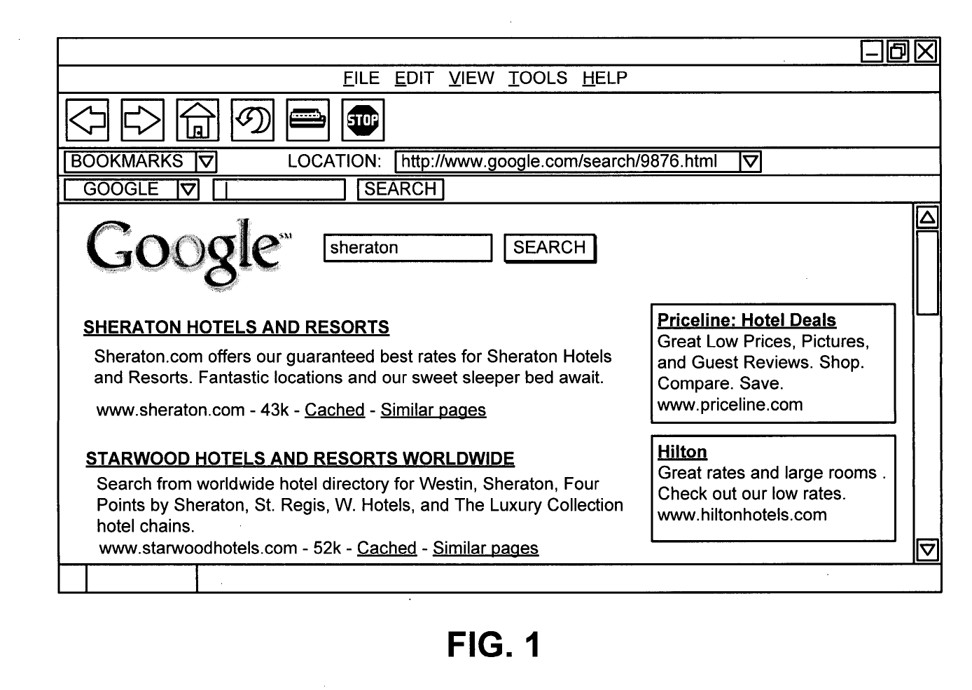

FIG. 1 is an exemplary diagram illustrating a concept consistent with the principles of the invention. As shown in FIG. 1, a user has performed a search for “Sheraton,” which is a trademark of The Sheraton Corporation. Along with the search results, the user may be presented with a set of advertisements. In the example of FIG. 1, one of the advertisements may include an authorized use of the Sheraton trademark, whereas the other advertisement may include an unauthorized use of the Sheraton trademark.

The advertisement of Priceline.com, for example, may include an authorized use of the Sheraton trademark. Assume that the Priceline.com advertisement may list as one of its keywords the Sheraton trademark to cause the advertisement to be displayed when the user performs a search for “Sheraton.” Further assume that The Sheraton Corporation gives permission to Priceline.com to use its trademark. Therefore, use of the Sheraton trademark by Priceline.com might qualify as an authorized use of the Sheraton trademark.

The advertisement of Hilton, on the other hand, may include an unauthorized use of the Sheraton trademark. Assume that the Hilton advertisement may list as one of its keywords the Sheraton trademark to cause the advertisement to be displayed when the user performs a search for “Sheraton.” Further assume that The Sheraton Corporation does not give permission to its competitors (e.g., Hilton) to use its trademark. Therefore, use of the Sheraton trademark by Hilton might qualify as an unauthorized use of the Sheraton trademark.

Implementations described herein are capable of reviewing millions of advertisements and hundreds of millions of keywords to detect advertisements in which advertisers use trademarks that they are not authorized to use. One thing that makes this task difficult is that often a trademark has multiple meanings. For example, the word “Hertz” may be used in advertisements for radios and televisions where it has the meaning of a unit of frequency. Similarly, the word “Budget” may refer to a car rental company, or it may refer to a person or company's financial budget. The word “Sheraton” might be the name of a hotel, but it might also mean a type of guitar. The trademark “Pergo” refers to a type of flooring material, but it is also part of the name of a city in Italy, and it is also a common misspelling of the word “Perego” which is a brand of baby-stroller.

Implementations described herein may provide an efficient way to separate authorized uses from unauthorized uses of trademarks so that advertisements containing unauthorized uses can be disabled without disabling advertisements containing authorized uses of trademarks.

### Exemplary Network Configuration

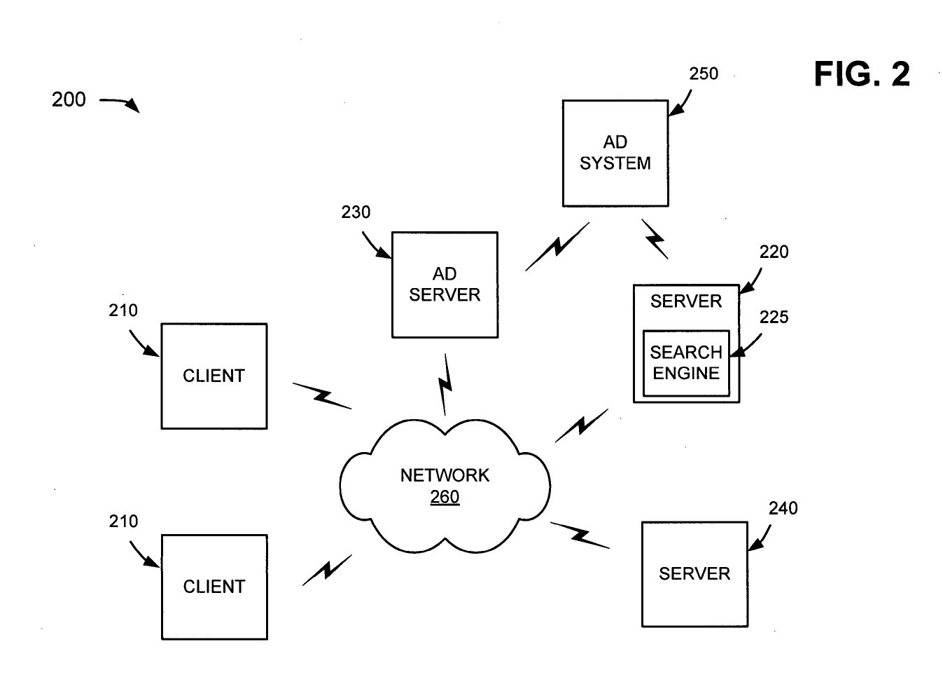

FIG. 2 is an exemplary diagram of a network 200 in which systems and methods consistent with the principles of the invention may be implemented. Network 200 may include multiple clients 210, multiple servers 220-240, an ad system 250, and a network 260. While network 200 has been shown to include a particular number and arrangement of components (e.g., clients 210, servers 220-240, ad system 250, and network 260), in practice, there may be more or fewer components and/or differently arranged components.

Clients 210 may include client entities. An entity may be defined as a device, such as a personal computer, a wireless telephone, a personal digital assistant (PDA), a lap top, or another type of computation or communication device, a thread or process running on one of these devices, and/or an object executable by one of these devices. Servers 220-240 may include server entities that gather, process, search, and/or maintain documents in a manner consistent with the principles of the invention.

In an implementation consistent with the principles of the invention, server 220 may include a search engine 225 usable by clients 210. Server 220 may crawl a corpus of documents (e.g., e-mails, web sites, web pages, files, news group postings, blogs, business listings, electronic versions of printed text, advertisements, etc.), index the documents, and store information associated with the documents in a repository of documents. Search engine 225 may provide search results or individual documents to clients 210. Ad server 230 may serve advertisements for search results or individual documents provided to clients 210. Server 240 may store or maintain documents that may be crawled or analyzed by server 220.

While servers 220-240 are shown as separate entities, it may be possible for one or more of servers 220-240 to perform one or more of the functions of another one or more of servers 220-240. For example, it may be possible that two or more of servers 220-240 are implemented as a single server. It may also be possible for a single one of servers 220-240 to be implemented as two or more separate (and possibly distributed) devices.

Ad system 250 may include an entity that detects authorized and unauthorized uses of trademarks within advertisements. In one implementation, ad system 250 may use a pipeline of filters to separate authorized trademark use from unauthorized trademark use, as described in more detail below. While ad system 250 is shown as separate from servers 220 and 230, it may be possible for server 220 and/or server 230 to perform one or more of the functions of ad system 250. For example, ad system 250 might be implemented within server 220 or server 230 in an implementation consistent with the principles of the invention.

Network 260 may include a local area network (LAN), a wide area network (WAN), a telephone network, such as the Public Switched Telephone Network (PSTN), an intranet, the Internet, or a combination of networks. Clients 210 and servers 220-240 may connect to network 250 via wired, wireless, and/or optical connections.

### Exemplary Entity Architecture

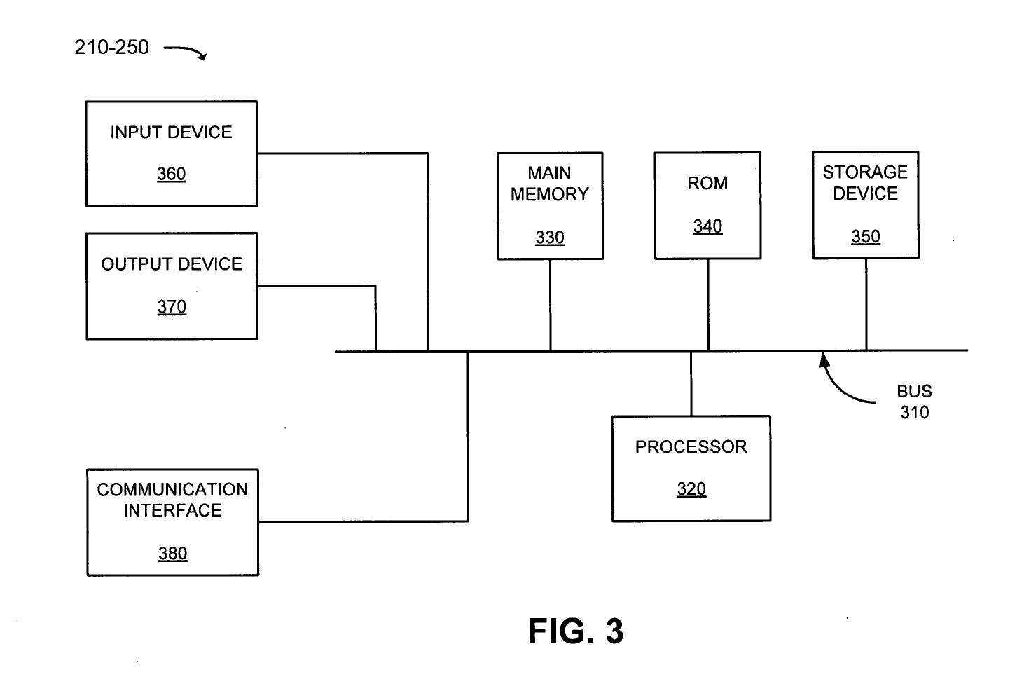

FIG. 3 is an exemplary diagram of an entity that may correspond to one or more of clients 210, servers 220-240, or ad system 250 of FIG. 2. The entity may include a bus 310, a processor 320, a main memory 330, a read only memory (ROM) 340, a storage device 350, an input device 360, an output device 370, and a communication interface 380. Bus 310 may include a path that permits communication among the elements of the entity.

Processor 320 may include a processor, microprocessor, or processing logic that may interpret and execute instructions. Main memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive.

Input device 360 may include a mechanism that permits an operator to input information to the entity, such as a keyboard, a mouse, a pen, voice recognition and/or biometric mechanisms, etc. Output device 370 may include a mechanism that outputs information to the operator, including a display, a printer, a speaker, etc. Communication interface 380 may include any transceiver-like mechanism that enables the entity to communicate with another entity. For example, communication interface 380 may include mechanisms for communicating with another entity via a network, such as network 260.

As will be described in detail below, the entity may perform certain operations relating to the detection of unauthorized uses of trademarks. The entity may perform these operations in response to processor 320 executing software instructions contained in a computer-readable medium, such as memory 330. A computer-readable medium may be defined as a physical or logical memory device and/or carrier wave.

The software instructions may be read into memory 330 from another computer-readable medium, such as data storage device 350, or from another entity via communication interface 380. The software instructions contained in memory 330 may cause processor 320 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

### Exemplary Ad System Functional Diagram

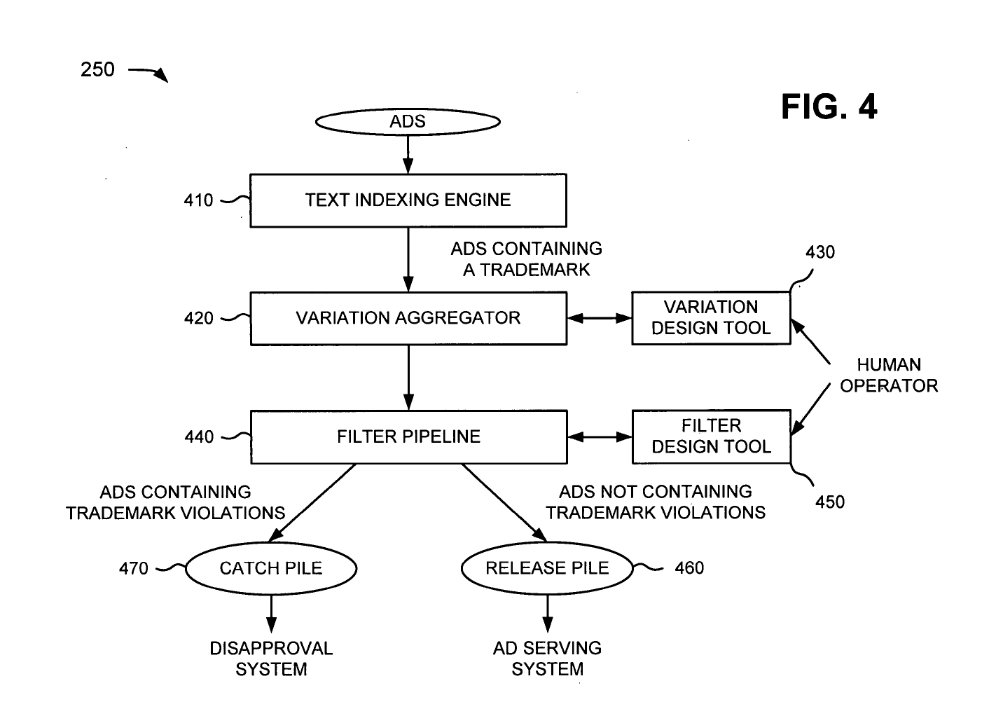

FIG. 4 is an exemplary functional block diagram of a portion of ad system 250 of FIG. 2. Ad system 250 may include text indexing engine 410, variation aggregator 420, variation design tool 430, filter pipeline 440, filter design tool 450, release pile 460, and catch pile 470. In one implementation, text indexing engine 410, variation aggregator 420, variation design tool 430, filter pipeline 440, and/or filter design tool 450 may be implemented by software and/or hardware within ad system 250.

Text indexing engine 410 may receive a set of advertisements and identify occurrences of trademarks. For example, text indexing engine 410 may use a text matching technique to determine whether the text of an advertisement or the keywords associated with the advertisement match a list of trademarks to identify any trademarks in the advertisement. In one implementation, the list of trademarks may include possible spelling variations (including common misspellings) for each of the trademarks. For example, for the trademark “center parc,” the following spelling variations may also be included in the list of trademarks: center pares, center park, center parks, centerparc, centre parc, centre pares, centre park, and centre parks. Text indexing engine 410 may consider each trademark (including each spelling variation) in the list separately when identifying occurrences of trademarks in the advertisements.

Text indexing engine 410 may create an index for each trademark in the list. For example, text indexing engine 410 may create one index for “center parc,” another index for “center park,” yet another index for “center parks,” and so on. Each index may identify all advertisements that contain the trademark. Text indexing engine 410 may provide the indexes it creates to variation aggregator 420.

Variation aggregator 420 may take possible spelling variations (including common misspellings) of a given trademark and produce a merged set of advertisements having one or more occurrences of the trademark or any of its spelling variations. For example, for the center parc trademark, variation aggregator 420 may produce a merged set of advertisements having one or more occurrences of center parc, center pares, center park, center parks, centerparc, centre parc, centre pares, centre park, or centre parks. Variation aggregator 420 may identify the advertisements for the merged set of advertisements from the indexes provided by text indexing engine 410. Variation aggregator 420 may then provide each advertisement in the merged set of advertisements to filter pipeline 440.

Variation design tool 430 may provide an interface that permits a human operator to define the set of spelling variations that are applicable for a given trademark. For example, the operator may add the spelling variations center pares, center park, center parks, centerparc, centre parc, centre parcs, centre park, and centre parks for the center parc trademark.

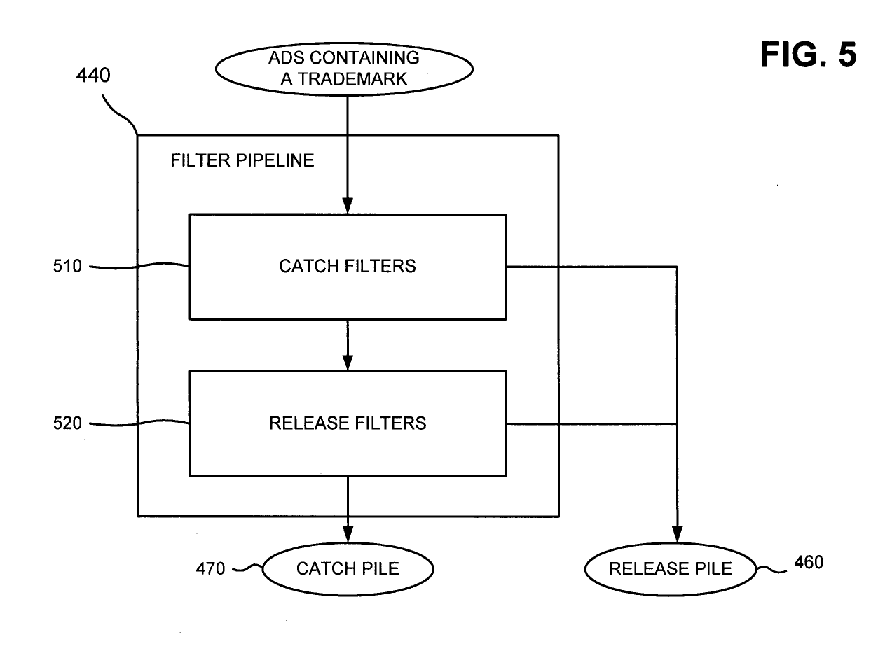

Filter pipeline 440 may execute for each trademark and apply a set of filtering rules to the advertisements that contain that trademark (or any of its spelling variations). FIG. 5 is an exemplary functional block diagram of filter pipeline 440. Filter pipeline 440 may include a set of catch filters 510 and a set of release filters 520. Each of catch filters 510 and release filters 520 may include sequential stages of filters.

The filter stages may be executed sequentially to either move an advertisement to release pile 460 or pass the advertisement along to the next filter stage. If an advertisement is moved to release pile 460, then it is deemed to be non-infringing (i.e., not a trademark violation). If an advertisement is caught by a filter stage, then it is passed to the next filter stage. If the advertisement is caught by the final filter stage of filter pipeline 440, then it may be moved to catch pile 470. If an advertisement is moved to catch pile 470, then it is deemed to be infringing (i.e., a trademark violation).

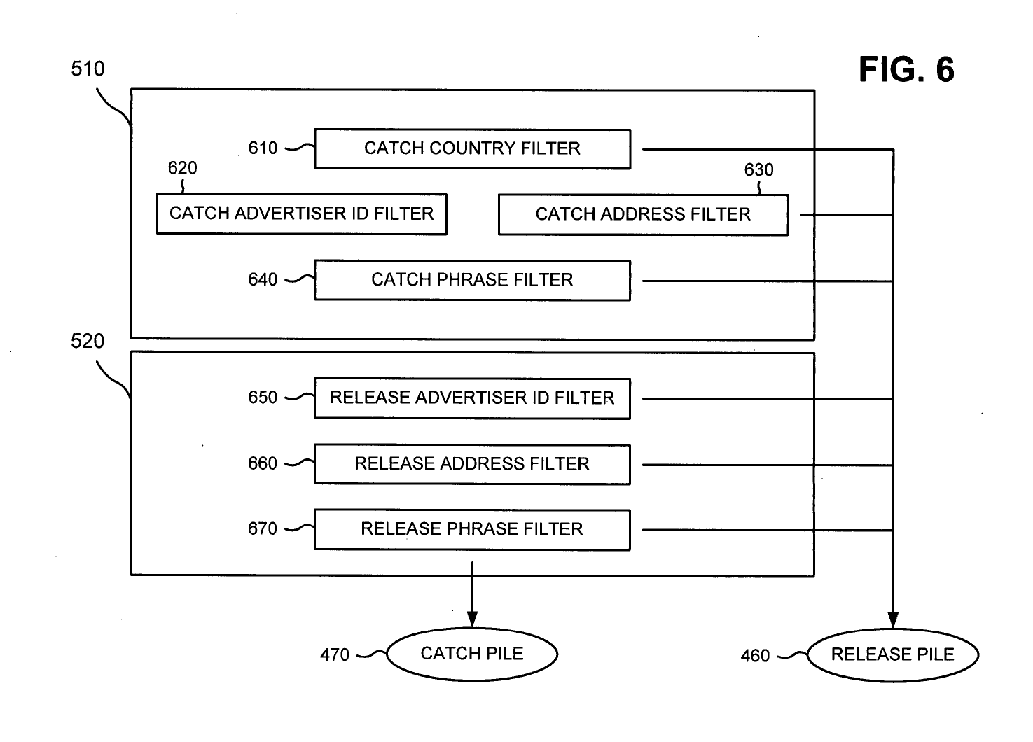

FIG. 6 is an exemplary functional block diagram of catch filter 510 and release filter 520. As shown in FIG. 6, catch filter 510 may include catch country filter 610, catch advertiser identifier (ID) filter 620, catch address filter 630, and catch phrase filter 640.

For catch country filter 610, a human operator may identify the specific set of countries where the trademark owner has registered the trademark. For example, if The Sheraton Corporation registered the trademark “Sheraton” in the United States, Canada, and the United Kingdom, then the operator may identify these countries in catch country filter 610. Each advertisement may include a set of target countries for which the advertisement is targeted. Catch country filter 610 may examine the set of target countries which are listed for an advertisement. If there is no overlap between the targeted countries and the countries provided by the operator, the advertisement may be moved to release pile 460. Otherwise, the advertisement may be passed to catch advertiser ID filter 620 and/or catch address filter 630.

For catch advertiser ID filter 620, a human operator may provide a list of advertiser account IDs that are known to be misusing a trademark. For example, a trademark owner may identify a specific advertiser's advertisements that are infringing its trademark. The operator may include the account IDs corresponding to this advertiser in catch advertiser ID filter 620. Catch advertiser ID filter 620 may determine whether the advertiser account ID associated with an advertisement matches one of the advertiser account IDs provided by the operator.

For catch address filter 630, a human operator may provide a list of addresses (e.g., URLs) that are known to be misusing a trademark. For example, a trademark owner may identify a small set of advertisements that are infringing its trademark by identifying the specific web sites or domains pointed to by the advertisements. The operator may include the addresses associated with these web sites or domains in catch address filter 630.

If either catch advertiser ID filter 620 or catch address filter 630 is non-empty (i.e., contains at least one advertiser account ID in the case of catch advertiser filter 620 or contains at least one address in the case of catch address filter 630), then only advertisements caught by one or both of these filters may pass along to the next stage of filter pipeline 440. All other advertisements may be moved to release pile 460. If both catch advertiser ID filter 620 and catch address filter 630 are empty, then the advertisements may be passed to catch phrase filter 640.

For catch phrase filter 640, a human operator may provide a set of words or phrases (“catch keywords”) that relate to a topic with which the trademark is associated. For example, if the operator is building filter pipeline 440 for the trademark “Budget” (a trademark of the car rental company Budget), the operator may provide words, such as car, automobile, truck, rental, rent, and hire into catch phrase filter 640. If catch phrase filter 640 determines that an advertisement contains none of the catch keywords (either in the content of the advertisement or its keywords), then catch phrase filter 640 may move the advertisement to release pile 460. Otherwise, catch phrase filter 640 may pass the advertisement to release filter 520.

As shown in FIG. 6, release filter 520 may include release advertiser ID filter 650, release address filter 660, and release phrase filter 670. For release advertiser ID filter 650, a human operator may identify advertiser accounts of the trademark owner and specific advertiser accounts that have been granted permission to use the trademark by the trademark owner. For example, the car rental company Budget (i.e., the owner of the Budget trademark) may permit expedia.com (an advertiser of travel accommodations) to use its trademark. The operator may include the account IDs corresponding to the trademark owner and the permitted advertisers in release advertiser ID filter 650. Release advertiser ID filter 650 may determine whether the advertiser associated with an advertisement matches one of the advertiser account IDs provided by the operator. If release advertiser ID filter 650 contains an advertiser account ID that matches the advertiser associated with an advertisement, then release advertiser ID filter 650 may move the advertisement to release pile 460. Otherwise, release advertiser ID filter 650 may pass the advertisement to release address filter 660.

For release address filter 660, a human operator may provide a list of addresses (e.g., URLs that are visible on the screen to the end user) that are associated with the trademark owner or are known to be unrelated to the business of the trademark owner. For example, in the case of Hertz, the operator could include the addresses hertz.com and hertzaudio.de in release address filter 660. This may cause advertisements pointing at the Hertz audio store to be removed from further consideration since any advertisement displaying this address is almost certainly unrelated to car rentals. The operator may include these addresses in release address filter 660. Release address filter 660 may determine whether the address associated with an advertisement matches one of the addresses provided by the operator. If release address filter 660 contains an address that matches the address associated with an advertisement, then release address filter 660 may move the advertisement to release pile 460. Otherwise, release address filter 660 may pass the advertisement to release phrase filter 670.

For release phrase filter 670, a human operator may provide a set of words or phrases (“release keywords”) that are unrelated to a topic with which the trademark is associated. For example, if the operator is building filter pipeline 440 for the trademark “Sheraton” (a trademark of the hotel company The Sheraton Corporation), the operator may provide a word, such as guitar (Sheraton is a type of guitar) into release phrase filter 670. If release phrase filter 670 determines that an advertisement contains any of the release keywords (either in the content of the advertisement or its keywords), then release phrase filter 670 may move the advertisement to release pile 460. Otherwise, release phrase filter 670 may move the advertisement to catch pile 470.

If a catch filter 610-640 is empty (i.e., the human operator did not provide any items), then it is assumed that the operator intends for the filter to have no effect and so advertisements are passed to the next stage in filter pipeline 440. If a release filter 650-670 is empty, then it is assumed that the operator intends for the filter to have no effect and so advertisements are passed to the next stage in filter pipeline 440 or to catch pile 470.

Returning to FIG. 4, filter design tool 450 may permit human operators to edit the contents of each of the filters of filter pipeline 440. Filter design tool 450 may also permit operators to experiment with different filter combinations. The operator may examine the output of each filter in filter pipeline 440, and can iteratively refine each filter to give optimal results for a particular trademark. Once the operator is satisfied with the performance of filter pipeline 440, the operator can run filter pipeline over all advertisements containing a particular trademark.

Release pile 460 may represent the collection of advertisements that were found to not contain trademark violations (i.e., non-infringing advertisements). These advertisements may be identified to an advertisement serving system, such as ad server 230 (FIG. 2). The advertisement serving system may display these advertisements to end users that perform searches using a search engine, such as search engine 225 (FIG. 2), or access a document via a server, such as server 220.

Catch pile 470 may represent the collection of advertisements that were found to contain trademark violations (i.e., infringing advertisements). These infringing advertisements may be submitted to a disapproval system. The disapproval system may change the status of these advertisements (e.g., deactivate them) so they may no longer be displayed to end users. The disapproval system may also notify the advertisers associated with these advertisements of deactivation of their advertisements.

### Exemplary Processing

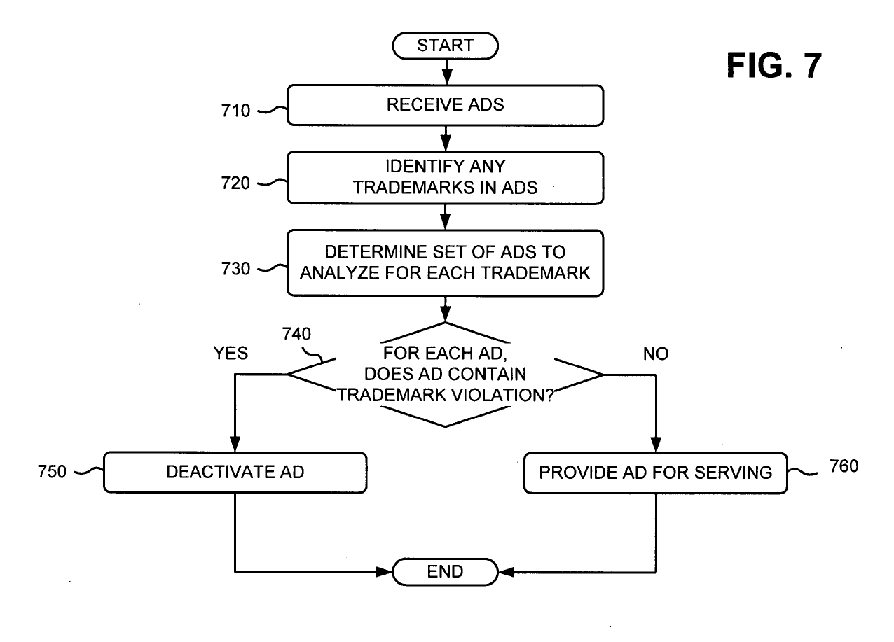

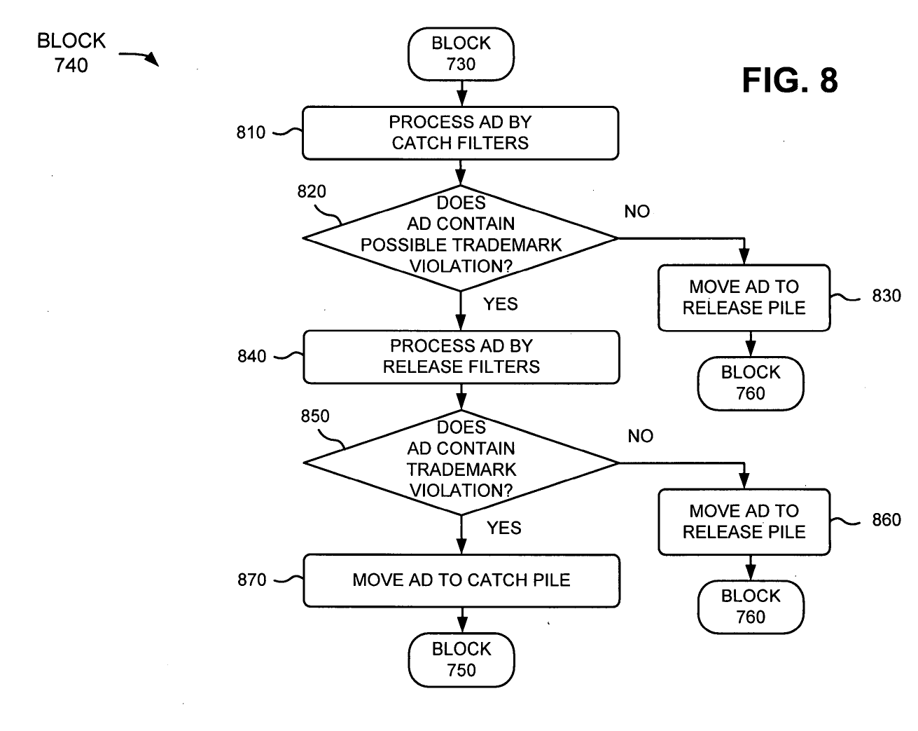

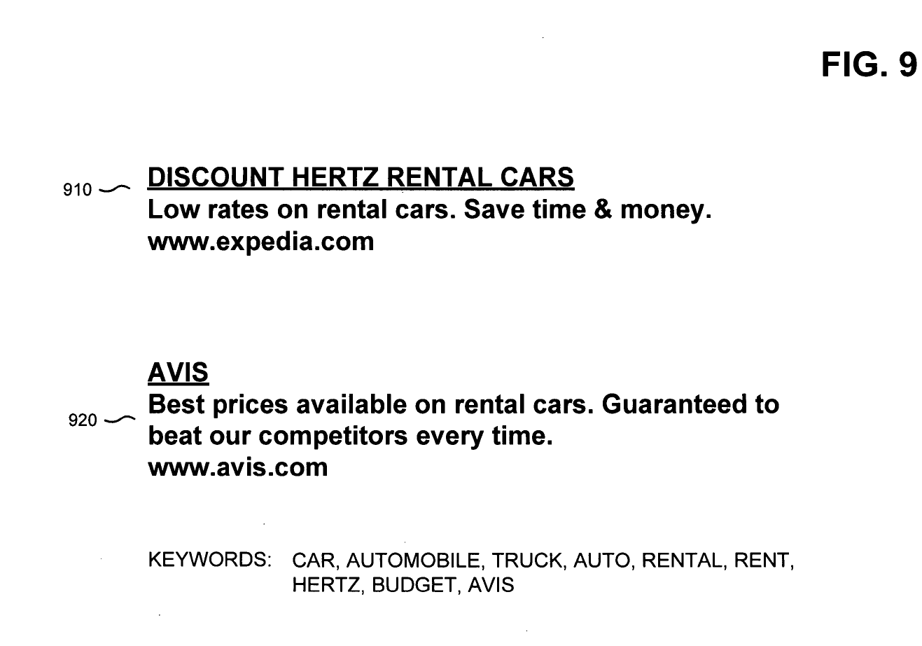

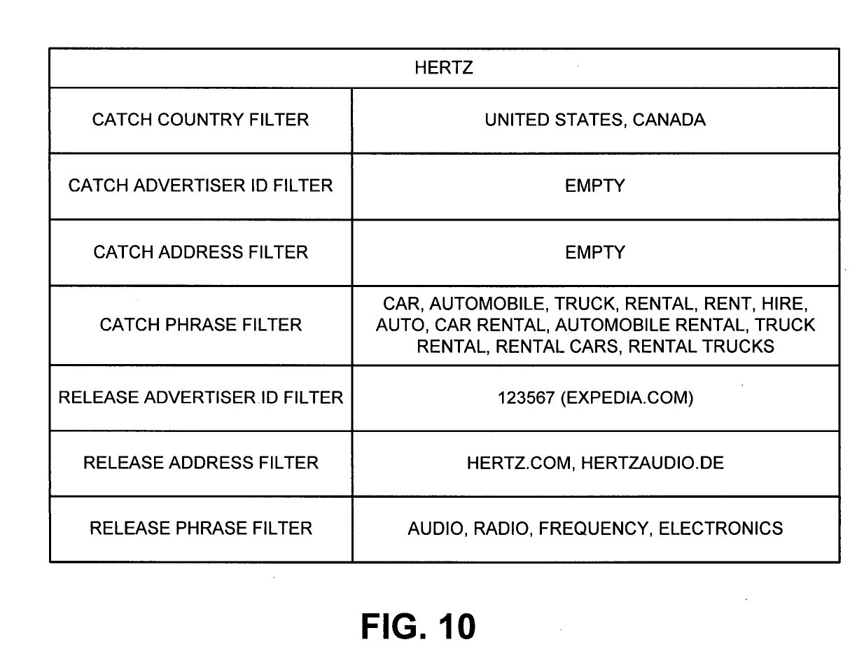

FIGS. 7 and 8 are flowcharts illustrating an exemplary operation for processing advertisements according to an implementation consistent with the principles of the invention. FIGS. 9 and 10 are diagrams that facilitate description of the exemplary operation of FIGS. 7 and 8.

Processing may begin with the receipt of a group of advertisements to be processed for potential trademark violations (block 710) (FIG. 7). The group of advertisements may include advertisements served by an ad server, such as ad server 230, and/or advertisements newly submitted for serving by the ad server.

The advertisements may be analyzed to identify any trademarks contained in the advertisements (including their keywords) (block 720). For example, each of the advertisements may be analyzed to determine whether its content or keywords include a trademark included in a list of trademarks. As explained above, the list of trademarks may include known trademarks and possible spelling variations of the trademarks. Each trademark (including each spelling variation) in the list may be considered separately when identifying occurrences of trademarks in the advertisements.

A set of advertisements to analyze for each trademark may be determined (block 730). For each trademark, possible spelling variations (including common misspellings) may be identified. The advertisements containing the trademark or one of its spelling variations may be determined and merged into the set of advertisements associated with the trademark.

For the discussion to follow, assume that the set of advertisements associated with the Hertz trademark owned by the Hertz rental car company includes two advertisements. As shown in FIG. 9, advertisement 910 is associated with the provider of travel accommodations Expedia and advertisement 920 is associated with the car rental company Avis. Assume that advertisements 910 and 920 contain identical keywords: car, automobile, truck, auto, rent, rental, Hertz, Budget, and Avis, and both are targeted to the United States.

For each advertisement in the set of advertisements, it may be determined whether the advertisement contains a trademark violation (block 740). As shown in FIG. 8, the advertisement may be processed by the catch filters (block 810). For example, the advertisement may be processed by catch country filter 610 (FIG. 6), catch advertiser ID filter 620, catch address filter 630, and catch phrase filter 640. The processing by the catch filters may indicate whether a particular advertisement contains a possible trademark violation (block 820).

Assume that catch country filter 610 indicates that the Hertz trademark is registered in the United States and Canada, catch advertiser ID filter 620 and catch address filter 630 are empty, and catch phrase filter 640 includes the following catch keywords: car, automobile, truck, rental, rent, hire, auto, car rental, automobile rental, truck rental, rental cars, and rental trucks, as shown in FIG. 10. When advertisements 910 and 920 are processed by catch country filter 610, catch advertiser ID filter 620, catch address filter 630, and catch phrase filter 640, both advertisements 910 and 920 may be identified as containing possible trademark violations.

For example, catch country filter 610 may determine that both advertisements 910 and 920 are targeted to a country in which the Hertz trademark is registered. For example, advertisements 910 and 920 are both targeted to the United States, which is a country in which the Hertz trademark is registered. Catch country filter 610 may then pass both advertisements to catch advertiser ID filter 620 and/or catch address filter 630. Because both catch advertiser ID filter 620 and catch address filter 630 are empty, advertisements 910 and 920 may be passed to catch phrase filter 640. Catch phrase filter 640 may determine that both advertisements 910 and 920 contain one or more of the catch keywords. For example, advertisements 910 and 920 contain the catch keywords: car, rental, automobile, truck, rent, auto, and rental cars.

If the advertisement does not contain a trademark violation, the advertisement may be moved to the release pile (block 830). Otherwise, the advertisement may be processed by the release filters (block 840). For example, the advertisement may be processed by release advertiser ID filter 650 (FIG. 6), release address filter 660, and release phrase filter 670. The processing by the release filters may indicate whether a particular advertisement contains a trademark violation (block 850).

Assume that release advertiser ID filter 650 contains the advertiser account ID 123567 associated with Expedia, release address filter 660 contains the addresses hertz.com and hertzaudio.de, and release phrase filter 670 includes the following release keywords: audio, radio, frequency, and electronics, as shown in FIG. 10. When advertisements 910 and 920 are processed by release advertiser ID filter 650, release address filter 660, and release phrase filter 670, advertisement 910 may be identified as not containing a trademark violation and advertisement 920 may be identified as containing a trademark violation.

For example, release advertiser ID filter 650 may determine that it contains the account ID associated with Expedia, but not Avis. Therefore, release advertiser ID filter 650 may move advertisement 910 to the release pile and may pass advertisement 920 to release address filter 660. Release address filter 660 may determine that the address associated with advertisement 920 (i.e., avis.com) does not match one of its addresses (i.e., hertz.com or hertzaudio.com) and, therefore, may pass advertisement 920 to release phrase filter 670. Release phrase filter 670 may determine that advertisement 920 does not match any of its release keywords. In other words, release phrase filter 670 may determine that the content and/or keywords of advertisement 920 do not match its release keywords. Accordingly, release phrase filter 670 may move advertisement 920 to the catch pile.

As explained above, when the release filters determine that an advertisement does not contain a trademark violation, the advertisement may be moved to the release pile (block 860). When the release filters determine that an advertisement does contain a trademark violation, the advertisement may be moved to the catch pile (block 870).

Returning to FIG. 7, an advertisement that is identified as containing a trademark violation (i.e., an advertisement in the catch pile) may be deactivated (block 750). In one implementation, an infringing advertisement may be submitted to a disapproval system that may change the status of the advertisement (e.g., deactivate it) so it may no longer be displayed to end users.

The disapproval system may notify the advertiser associated with this advertisement of deactivation of the infringing advertisement. The advertiser may be given the option of revising the text in the infringing advertisement, or submitting an explanation of why it believes the use of the trademark should be permitted. If the explanation is satisfactory, the human operator may revise the corresponding filter pipeline so that similar advertisements in the future will not be incorrectly identified as containing trademark violations.

An advertisement that is identified as not containing a trademark violation (i.e., an advertisement in the release pile) may be provided for serving (block 760). For example, the advertisement may be provided to an advertisement serving system, such as ad server 230 (FIG. 2). The advertisement serving system may display the advertisement to end users that perform searches using a search engine, such as search engine 225 (FIG. 2), or access a document via a server, such as server 220. The advertisement serving system may use existing techniques to determine which advertisements to display in connection with a set of search results or an accessed document.

### CONCLUSION

Implementations consistent with the principles of the invention may detect violations in advertisements. Implementations described herein can detect violations that appear in the advertisement text itself and in the keywords used to trigger the display of the advertisement text. While the preceding description focused on trademark violations, the description equally applies to other types of violations, such as unauthorized use of copyrights, service marks, trade names, and/or other forms of intellectual property, or the use of restricted words.

The foregoing description of implementations consistent with the principles of the invention provides illustration and description, but is not intended to be exhaustive or to limit the invention to the precise form disclosed. Modifications and variations are possible in light of the above teachings or may be acquired from practice of the invention.

For example, while series of acts have been described with regard to FIGS. 7 and 8, the order of the acts may be modified in other implementations consistent with the principles of the invention. Further, non-dependent acts may be performed in parallel.

Also, while FIG. 6 shows a particular set and arrangement of catch filters 610-640 and release filters 650-670, the filters used within filter pipeline 440 may vary or be differently arranged in other implementations consistent with the principles of the invention.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1-36. (canceled)

37. A method comprising:
receiving, by one or more processors, information regarding an advertisement of an advertiser;
determining, by the one or more processors, that the advertisement includes a particular word or a particular phrase;
determining, by the one or more processors, whether the advertiser is authorized to use the particular word or the particular phrase in the advertisement by:
determining whether an electronic web address, that a user device visits in response to a user click of the advertisement matches an electronic web address of an authorized advertiser that is authorized to use the particular word or the particular phrase,
the advertiser being authorized to use the particular word or the particular phrase in the advertisement when the address, pointed to by the advertisement, matches the address associated with the authorized use of the particular word or the particular phrase; and
selectively providing, by the one or more processors and to the user device for display, the advertisement based on a filter pipeline including i) a catch filter specifying whether the advertiser is authorized to use the particular word or the particular phrase in the advertisement, and ii) a release filter specifying a set of filter words that, when detected in combination with the particular word or the particular phrase in the advertisement, authorizes the advertiser to use the particular word or the particular phrase, including:
providing the advertisement to the user device for display when it is determined that the advertiser is authorized to use the particular word or the particular phrase in the advertisement based on the particular word or the particular phrase being included in the catch filter and at least one of the set of filter words specified by the release filter being included in the advertisement; and
declining, by the one or more processors, to provide the advertisement to the user device for display when it is determined that the advertiser is not authorized to use the particular word or the particular phrase in the advertisement based on the particular word or particular phrase being included in the catch filter and none of the filter words specified by the release filter being included in the advertisement.

38. The method of claim 37, where selectively providing the advertisement to the user device for display includes:
providing the advertisement, to the user device for display, with one or more search results of a search query.

39. The method of claim 37, where the electronic web address, of an authorized advertiser that is authorized to use the particular word or the particular phrase, corresponds to an electronic web address that is unrelated to a business of an owner of the particular word or the particular phrase.

40. The method of claim 37, where the electronic web address, of an authorized advertiser that is authorized to use the particular word or the particular phrase, corresponds to a web site or a domain.

41. The method of claim 37, where the particular word or the particular phrase is registered in a particular location, and
where the method further comprises determining that the advertisement is directed to the particular location.

42. The method of claim 41, where determining whether the advertiser is authorized to use the particular word or the particular phrase in the advertisement includes:
determining whether the advertiser is authorized to use the particular word or the particular phrase in the advertisement after determining that the advertisement is directed to the particular location.

43. The method of claim 37, where determining whether the advertiser is authorized to use the particular word or the particular phrase in the advertisement further includes:
determining whether one or more words, related to the advertisement, match one or more words related to a topic of the particular word or the particular phrase; and
determining that the advertiser is authorized to use the particular word or the particular phrase in the advertisement when the one or more words, related to the advertisement, do not match the one or more words related to the topic of the particular word or the particular phrase.

44. (canceled)

45. A system comprising:
a memory to store instructions; and
one or more processors to execute the instructions to:
receive information regarding an advertisement of an advertiser,
determine that the advertisement includes a particular word or a particular phrase,
determine whether the advertiser is authorized to use the particular word or the particular phrase in the advertisement, and
selectively provide, for display, the advertisement based on a filter pipeline including i) a catch filter specifying whether the advertiser is authorized to use the particular word or the particular phrase in the advertisement, and ii) a release filter specifying a set of filter words that, when detected in combination with the particular word or the particular phrase in the advertisement, authorizes the advertiser to use the particular word or the particular phrase, including:
provide the advertisement for display when it is determined that the advertiser is authorized to use the particular word or the particular phrase in the advertisement based on the particular word or the particular phrase being included in the catch filter and at least one of the set of filter words specified by the release filter being included in the advertisement; and
decline to provide the advertisement for display when it is determined that the advertiser is not authorized to use the particular word or the particular phrase in the advertisement based on the particular word or particular phrase being included in the catch filter and none of the filter words specified by the release filter being included in the advertisement.

46. (canceled)

47. The system of claim 45, where, when selectively providing the advertisement for display, the one or more processors are to:
provide the advertisement, for display, with one or more search results of a search query.

48. The system of claim 45, where, when determining whether the advertiser is authorized to use the particular word or the particular phrase, the one or more processors are to:
determine whether an electronic web address, that a user device visits in response to a user click of the advertisement matches an electronic web address of an authorized advertiser that is authorized to use of the particular word or the particular phrase, and
determine that the advertiser is authorized to use the particular word or the particular phrase in the advertisement of the advertiser when the electronic web address, that a user device visits in response to a user click of the advertisement matches an electronic web address of an authorized advertiser that is authorized to use of the particular word or the particular phrase,
where the electronic web address, of an authorized advertiser that is authorized to use of the particular word or the particular phrase, corresponds to an address that is unrelated to a business of an owner of the particular word or the particular phrase, and
where the electronic web address, of an authorized advertiser that is authorized to use of the particular word or the particular phrase, corresponds to a web site or a domain.

49. The system of claim 45, where the information regarding the advertisement includes:
text of the advertisement, or
one or more keywords that cause the text of the advertisement to be displayed.

50. The system of claim 45, where, when determining whether the advertiser is authorized to use the particular word or the particular phrase in the advertisement, the one or more processors are further to:
receive, from an owner of the particular word or the particular phrase, one or more words related to a topic of the particular word or the particular phrase,
determine whether one or more words, related to the advertisement, match the one or more words related to the topic, and
determine that the advertiser is authorized to use the particular word or the particular phrase in the advertisement of the advertiser when the one or more words, related to the advertisement, do not match the one or more words related to the topic.

51. The system of claim 45, where the particular word or the particular phrase is registered in a particular location,
where the one or more processors are further to determine that the advertisement is directed to the particular location, and
where the one or more processors are to determine whether the advertiser is authorized to use the particular word or the particular phrase in the advertisement after determining that the advertisement is directed to the particular location.

52. A non-transitory computer readable medium storing instructions, the instructions comprising:
a plurality of instructions which, when executed by one or more processors, cause the one or more processors to:
receive information regarding an advertisement of an advertiser;
determine that the advertisement includes a particular word or a particular phrase, the particular word or the particular phrase being registered in a particular location;
determine that the advertisement is directed to the particular location;
determine whether the advertiser is authorized to use a particular word or a particular phrase after determining that the advertisement is directed to the particular location;
determine whether to provide the advertisement for display, based on determining whether the advertiser is authorized to use the particular word or the particular phrase; and
selectively provide, for display, the advertisement based on determining i) whether the advertiser is authorized to use the particular word or the particular phrase in the advertisement of the advertiser, and ii) a set of filter words that, when detected in combination with the particular word or the particular phrase in the advertisement, authorizes the advertiser to use the particular word or the particular phrase, including:
provide the advertisement for display when it is determined that the advertiser is authorized to the particular word or the particular phrase in the advertisement based on the particular word or the particular phrase being included in the catch filter and at least one of the set of filter words specified by the release filter being included in the advertisement; and
decline to provide the advertisement for display when it is determined that the advertiser is not authorized to use the particular word or the particular phrase in the advertisement based on the particular word or particular phrase being included in the catch filter and none of the filter words specified by the release filter being included in the advertisement.

53. The non-transitory computer readable medium of claim 52, where the particular word or the particular phrase corresponds to a service mark, a copyright, a trademark, or a trade name.

54. The non-transitory computer readable medium of claim 52, where the particular word or the particular phrase is registered in a particular location,
where the instructions further include:
one or more instructions to determine that the advertisement is directed to the particular location prior to determining whether the advertiser is authorized to use the particular word or the particular phrase.

55. The non-transitory computer readable medium of claim 52, where one or more instructions, of the plurality of instructions, to determine whether the advertiser is authorized to use the particular word or the particular phrase include:
one or more instructions to determine whether one or more words, related to the advertisement, match one or more words related to a topic of the particular word or the particular phrase; and
one or more instructions to determine that the advertiser is authorized to use the particular word or the particular phrase in the advertisement when the one or more words, related to the advertisement, do not match the one or more words related to the topic.

56. (canceled)
